(19) United States
(12) Patent Application Publication
(10) Pub. No.: US 2007/0182052 A1
(43) Pub. Date: Aug. 9, 2007

(54) Method and device for pulverizing bulk material containing plastic

(76) Inventors: Matthias Falkenberg, Eupen (BE); Gunter Falkenberg, Eupen (BE)

Correspondence Address: WILLIAM COLLARD;COLLARD & ROE, P.C., 1077 NORTHERN BOULEVARD, ROSLYN, NY, 11576, US

(21) Appl. No.: 11/643,612

(22) Filed: Dec. 21, 2006

(30) Foreign Application Priority Data
Dec. 23, 2005 (DE) 10 2005 062 434.0

(51) Int. Cl. B29B 9/00

(52) U.S. Cl. 264/140; 264/319; 425/308; 425/200

(57) ABSTRACT

In a method and a device for pulverizing bulk material containing plastic, whose grain is highly flexible and whose loose bulk is highly compressible and which is initially provided in a coarse grain, is subsequently heated and compressed and is then converted into a finer grain, the bulk material at least partially contains thermoplastics. Before and/or during and/or after the compression, the bulk material is at least partially melted in such a way that it is provided in the form of an endless strand or slab after the compression and heating, which is cooled and converted into the finer grain in a coherent state using a cutting tool, the thickness of the strand or the slab being between 5.0 mm and 100 mm, preferably between 10 mm and 50 mm, the bulk material in the fine grain having a grain size in the range from 0.0 mm to 20 mm, preferably from 0.0 mm to 5.0 mm, more preferably from 0.0 mm to 2.0 mm.

### CROSS-REFERENCE TO RELATED APPLICATIONS

Applicants claim priority under 35 U.S.C. §119 of German Application No. 10 2005 062 434.0 filed Dec. 23, 2005.

### BACKGROUND OF THE INVENTION

1. Field of the Invention

The present invention relates to a method for pulverizing bulk material containing plastic, whose grain is highly flexible and whose loose bulk is highly compressible and which is initially provided in a coarse grain, subsequently heated and compressed, and then converted into a finer grain.

Furthermore, the present invention relates to a device for performing the method described above.

2. The Prior Art

A method of this type is known, for example, from DE 199 16 543 A1. The known method is used for reprocessing polyurethane elastomer products, which do not have thermoplastic, compact, or microcellular constructions. These are waste materials in form of add-on parts or other components, for example. Since polyurethane is very elastic as an elastomer, pulverizing wastes of this type represents a difficult problem. According to the previously known method, the wastes are first pulverized in a cutting mill to a grain size of 10 mm to 15 mm. The ground material thus produced is heated for the next step, up to a temperature of 90° C. to 120° C. Subsequently, the ground material is rolled in a rolling mill at a temperature of 120° C. to 210° C. The microcellular elastomers are degassed, compacted, and partially melted by this procedure. The compact elastomers are partially melted and also pulverized finely. After this procedure, the wastes become plastic, i.e., the elasticity of the elastomer polyurethane is completely reduced. During the procedure of rolling under temperature, the macromolecules are destroyed under the high mechanical forces existing therein. After the rolling, the wastes, which are no longer elastic, are again pulverized to a grain size of 3 mm to 4 mm. This procedure is performed in a typical cutting mill according to the known method. After this polarization step, the wastes thus provided may be processed further in two different ways:

A first variation comprises compounding with thermoplastics or thermoplastic elastomers, which are compatible with the polyurethane, or may be compounded by compatibilizers. After the compounding, these mixtures are granulated. The granulates thus produced may be processed further by injection molding extrusion or calendering. The second variation of the further processing comprises compression of the pulverized wastes. They are compressed in a hydraulic press at a temperature of 160° C. to 210° C. and 100 bar to 300 bar in a mold and subsequently cooled to room temperature at the same pressure. The products thus produced may preferably be used further in the form of a slab, either in a compact or a foamed form.

The goal of the known method is the material reprocessing of the polyurethane wastes. The heating, compression, and subsequent conversion into a finer grain (in relation to the starting material) is used solely for the purpose of subsequently reshaping the waste material into a recycling material again via compounding or compression by injection molding, extrusion, or calendering and/or by renewed compression. However, recycling materials of this type have the problem of maintaining specific standards in regard to the material properties, since the composition of the polyurethane waste materials used as the starting material is typically not precisely known.

Furthermore, a device for pulverizing a bulk material, comprising rubber or carpet wastes, is disclosed in U.S. Pat. No. 6,082,642. The waste product in the coarser grain is very strongly compressed purely mechanically within a massively implemented cylinder-piston unit. A rapidly rotating cutting tool having multiple teeth is located in front of an outlet cross-section on the front side of the cylinder. Since the outlet cross-section is selected as very small and the edge of the outlet opening in the front face of the cylinder acts as a counter blade, a very fine grain like a powder may be produced. This powder material is to be supplied to the production process again, in particular if it is rubber, and is not to be used for combustion purposes because of the fear of pollutant development. This previously known method has the problem in particular of the discontinuous process during the compression, which only permits relatively low mass flows, if the device is not to assume disadvantageously large dimensions and thus also cause high investment costs.

A method and a device for pulverizing bulk material, in particular in the form of collected film wastes and especially, for example, shopping bags, pieces of blister packages, or large-format air cushions, are known from DE 102 34 763 A1. In the previously known method, the bulk material, which is initially provided in a coarse grain, is compressed in a purely mechanical way i.e., it is compressed purely mechanically—without heating, particularly without partially melting—and is converted into the finer grain in this compressed state by cutting with the aid of a rotating rasping tool. The grain size in this method is approximately 0.1 mm to multiple millimeters. Since the grain size scattering is low in the method, this previously known method is particularly suitable for producing a fine-grain plastic material, which is used as a secondary fuel in industrial combustion and is increasingly of interest as a cost-effective fuel in view of rising energy costs. The low scattering of the grain size is important in particular for the quality of a secondary fuel of this type, as is, however, the smallest possible grain size viewed absolutely, in order to produce a very large surface-volume ratio. This is important for complete combustion of the plastics without noticeable pollutant and soot development in view of the long chain hydrocarbon molecules present in the plastics.

A specific problem of the previously known methods is that the purely mechanical compression and cutting in this state requires a quite high energy expenditure as well as a construction outlay. The pressure at which the bulk material provided in coarse form is compressed and kept during the cutting procedure must be very high in order to prevent the cutting forces acting on the coarse grains during the cutting procedure from resulting in their displacement. In such a case, a uniform grain size of the material produced may not be ensured, which results in a quality loss in regard to the combustion properties.

A method and a device for converting foam parts into reusable plastic material is known from DE 41 28 046 A1. The foam parts may be, for example, polystyrene or other foams which are used in particular as packaging materials. Coarsely pulverized plastic material is milled in the cylinder using a screw and converted under the effect of heat and pressure into a free-flowing plastic mass, which is pressed through outlet nozzles to form a plastic strand. The plastic strand is subsequently pulverized into granulate using a cutter bar. The entire device is provided for one use, for example, in an electronics retail business, and has a total length of only approximately 60 cm. However, wastes which contain large components of thermoplastic materials, such as film parts and/or plastic packages, may not be disposed of using the known device for foam materials. Sufficiently small particles may also not be produced using the revolving cutter bar. The achievable grain size may be adequate for granulate which is subsequently melted during the further processing, but is unsatisfactory for further processing of the included particles as fuel to be blown in.

### SUMMARY OF THE INVENTION

Object

The present invention is based on the object of providing a method and a device for pulverizing bulk material, which allows pulverization of the bulk material to the smallest possible grain size having the lowest possible scatter of the size with the least possible outlay for apparatus.

Achievement of the Object

This object is achieved according to the present invention, proceeding from a method of the type described at the beginning, in that the bulk material, which at least partially contains a thermoplastic, is partially melted before and/or during and/or after the compression in such a way that it is provided in the form of an endless strand or a slab after the compression and heating, which is cooled and converted in a coherent state into the finer grain using a cutting tool, the thickness of the strand or slab being between 5 mm and 100 mm, preferably between 10 mm and 50 mm, and the bulk material having a grain size in the finer grain in the range from 0.0 mm to 20 mm, preferably from 0.0 mm to 5.0 mm, more preferably between 0.0 mm and 2.0 mm.

The method according to the present invention, which is used in particular for producing secondary fuels, exploits the special properties of the thermoplastics contained in the bulk material to optimize the process of pulverizing. The partial melting of the bulk material in the coarse grain and the conversion into an endless strand or a slab is used as a contrivance for producing an intermediate product which has optimum cutting properties after sufficient cooling, i.e., hardening, in the meaning that the finer grain achievable upon the pulverization has a very small grain size and a very small grain size spectrum, i.e., a low variance of the grain size.

It may initially appear contradictory to first bring the material previously provided in loose bulk into the form of a compact strand or a compact slab, which is mechanically pulverized again in a later step with the aid of a cutting tool. The results achievable in this way in the product quality exceed those in the methods according to the prior art so significantly, however, that the required additional outlay is justified in every case. In addition, the energy outlay required for heating and subsequently cooling the compressed bulk product is comparatively low overall, if the heat released when cooling the strand or slab is used again to preheat the bulk material initially provided in the coarse grain as defined by intelligent energy reclamation. In addition, the energy loss may be minimized by an appropriate effective insulation of the areas in which the heating or also the cooling occur.

The thicknesses specified for the strand or slab as well as the grain size of the finer grain obtained after the cutting procedure have been shown to be especially advantageous in practice.

It is obvious that the method according to the present invention may be performed both continuously and also discontinuously, i.e., intermittently while processing one specific batch quantity at a time. A combination of a continuous or quasi-continuous, i.e., intermittent mode of operation of certain method steps (such as the heating) with a discontinuous mode of operation (for example, in the area of the compression) is also conceivable.

Bulk material in the form of a mixture of already presorted waste materials pre-pulverized using typical methods is to be used as a starting material in particular. Thus, for example, plastic wastes from households or industry, in particular packaging wastes, film wastes, container wastes, inter alia, come into consideration, but also carpet wastes either from carpet fabrication or used and discarded carpets. To a certain extent, elastomer plastic wastes may also be contained in the bulk material to be processed, such as foam parts or rubber parts. The component of foams may not exceed an upper limit of approximately 3.0%, however. A small component of wood materials is also tolerable. However, metallic materials, which would wear the cutting tools too rapidly, as well as halogenated plastics, which would result in an undesired pollutant development during the intended combustion of the final product, are not acceptable.

A sufficient content of thermoplastic material, which is at least regionally brought to its softening point or even melting point in the course of the heating of the material provided in coarse grain, is essential for the functioning of the method according to the present invention, so that the production of a coherent composite of the material in the form of a strand or slab is possible. Unmeltable and/or non-plasticizable components, such as wood, or elastomer materials, such as rubber or silicone materials, may then be contained in this composite. These then form small “inclusions”, i.e., “islands”, in an environment otherwise comprising plasticized plastic material. It is obvious that the unmeltable and possibly also incompressible components of the bulk material to be processed have a smaller extension in at least one dimension than the thickness of the strand or the slab to be compressed. The method is therefore suitable in particular for treating oblong and/or elongate parts of the bulk material to be utilized.

Furthermore, it is obvious that the temperature in the area of the heating device is advisably selected only high enough that a sufficiently strong coherence of the strand or slab is achieved upon the compression. If it is necessary because of a special composition of the starting material, however, complete melting of the thermoplastic components may be performed to achieve the desired properties of the strand or slab.

However, a composite solely produced by partial melting, in which air inclusions are still present to a certain extent in the strand or slab and, in addition, the individual grains of the bulk material (coarse grain) are more or less glued to one another, is preferred in particular. This state makes the subsequent conversion into the finer grain easier than a slab produced by melting through, the energy outlay during the pulverizing being limited by the looser composite. The looser composite makes the pulverizing procedure significantly easier than mere compression without partial melting, because significantly better fixing of the coarse grains may be achieved.

A possibility which is preferred in regard to the method comprises conveying the bulk material using a conveyor belt during the heating and heating it using a heating unit situated above the conveyor belt. The heat transfer from the heating unit to the conveyed bulk material may occur both via thermal radiation and also via convection using a hot gas and also via heat conduction, if the bulk material is in contact with a heated surface of the heating unit or an interposed transmission element. It is obvious that the three above-mentioned types of heat transmission may be used not only alternatively, but rather also cumulatively with one another. In addition to the heating from above, heating through the conveyor belt is also possible, since the thermal has a supporting effect in regard to good distribution of the heat within the bulk material stream, which has a certain thickness. In principle, all clean types of energy (fuels, such as oil, gas, solid fuels, or electrical energy) may be used for operating the heating unit.

The conveyor belt may either comprise a temperature-resistant rubber material, preferably having reinforcement inserts made of plastic or metal, or may be implemented as a metallic belt, in particular if heat transmission from the bottom of the belt to its top and/or the bulk material conveyed there is provided.

According to one embodiment of the method according to the present invention, it is suggested that the heating time, during which the bulk material is preferably stationary, i.e., is not moved in the conveyance direction, is at least 20 seconds, preferably at least 30 seconds. Furthermore, it has been shown to be particularly advantageous if the heating temperature is between 200° C. and 250° C. and the bulk material is compressed during the heating and/or is already compressed previously. The danger of ignition during heating of the not yet compressed bulk material is thus reduced, since the air content of the bulk material is significantly reduced after the compression.

Furthermore, it is possible to convey the bulk material between two conveyor belts or two rollers during the compression, the conveyor cross-section decreasing in the conveyance direction down to a delivery cross-section, whose height corresponds to the thickness of the strand or the slab. In the case of compression between two conveyor belts, their length may be selected in such a way that on the path to the delivery cross-section, heating of the bulk material at least to a softening point occurs simultaneously with the compression via the heating unit situated beforehand.

In a refinement of the method according to the present invention, a continuously or discontinuously conveyed stream of the bulk material is partially melted before the compression and then transferred into a compression chamber and compressed therein using a ram. In a method of this type, the conveyed stream of the bulk material in coarse grain may be partially melted quasi-continuously, to then be compressed by batches using the ram in a next step in accordance with the capacity of the compression chamber.

It is advantageous in regard to optimizing the method sequence if the stream of the bulk material is transferred into a collection chamber before the transfer into the compression chamber and the quantity of the partially molten bulk material collected therein is transferred into the compression chamber, the collection chamber and the compression chamber being located above a further conveyor belt, which delimits the two chambers on the bottom.

The second conveyor belt, which causes the transport from the collection chamber into the compression chamber and, furthermore, the transport of the slab thus produced in the direction toward the pulverizing device, allows, with a step-by-step intermittent advancing movement, the quasi-continuous operation of the first conveyor belt, on which the stream of the bulk material is partially melted. In order to make special contrivances superfluous for the transfer of the partially molten stream of the bulk material and in particular to avoid sticking of the partially molten bulk material and the danger of interference connected therewith, the stream of the molten bulk material is to be transferred by gravity from the first conveyor belt into the collection chamber, the movement of the conveyor belt being temporarily interrupted so that the transfer of the stream of the bulk material is also interrupted.

The object is achieved in regard to the device by a device for pulverizing bulk material containing plastic, whose grain is highly flexible and whose loose bulk is highly compressible and which is initially provided in a coarse grain, the device having a heating unit for heating the bulk material, a compression unit for compressing the but material, and a pulverizing unit for converting the bulk material into a finer grain, and being characterized in that, using a heating unit, the bulk material, which at least partially contains thermoplastics, may be at least partially melted before and/or during and/or after the compression in such a way that it is provided in the form of an endless strand or slab after the compression and heating and an endless strand or a slab of the bulk material is producible using the compression unit, the thickness of the strand or the slab being between 2 mm and 30 mm, preferably between 5 mm and 15 mm and a bulk material having a finer grain size, which is between 0.05 and 2.5 mm, preferably between 0.1 mm and 1.0 mm, is producible from the strand or the slab in the cooled state using the pulverizing unit.

If heat conduction through a conveyor unit for the not yet molten bulk material, preferably a conveyor belt, is to be avoided, the bulk material may be conveyed using a conveyor unit below the heating unit so that the heat acts on the bulk material from above.

In the case of discontinuous compression of the partially molten bulk material, the compression unit may have a ram, using which the partially molten bulk material is compressible in a compression chamber, whose bottom is preferably formed by a further conveyor belt and which has side walls to prevent a lateral yielding movement of the bulk material to be compressed.

To avoid excess length of the two conveyor belts situated one after another, the two conveyor belts may be situated at a right angle to one another.

In addition, according to the present invention, the further conveyor belt is provided with strips projecting above the conveyor surface, distributed equidistantly to one another in the longitudinal direction of the conveyor belt, whose clearance to one another corresponds to the length of a slab compressible in the compression chamber and whose height corresponds to the thickness of the compressible slab, the side walls of the compression chamber being situated at a vertical distance above the conveyor surface of the conveyor belt which is slightly greater than the height of the strips. In this way, both hermetic sealing of the compression chamber in the conveyance direction of the conveyor belt and/or the opposite direction and more secure removal of the compressed slabs are achieved. There is a form fit between the strips and the compressed slabs located between them which prevents slipping between the conveyor belt and the slabs during their transport.

In a further embodiment of the present invention, it is suggested that the pulverization unit comprises multiple angular rasping disks, which are joinable to one another axially, having rasping teeth projecting at the circumference, each individual rasping disk comprising multiple disk segments joined to one another around the circumference, which may be pushed using holes onto retention rods running parallel to one another in the axial direction, which may in turn be clamped between two clamping disks delimiting an assembly of the rasping disks at both ends.

Rasping disks of this type are sold by Rocket Sales AG in Baar, Switzerland, under the name R 115 REG Turbo. The rasping disks having rough blades of this type, which are interlaced with one another and comprise hardened steel, are typically used for roughening rubber tires before vulcanizing on further rubber materials, for example, when retreading tires, particularly in the aerospace industry. Rasping disks of this type have entirely outstanding effectiveness according to the present invention for the purpose according to the present application of producing a very small particle size in the production of secondary fuels from partially molten and compressed slab or strand material.

Furthermore, according to the present invention, a web material, preferably a paper, may be supplied to the bulk material before the heating on the top and/or the bottom of the strand or slab to be formed, the web material, whose width at least corresponds to the width of the strand to be formed, being able to be unwound from a roll before being supplied to the strand or slab and being able to be wound onto a roll after the separation from the strand or slab. The problem of sticking of the slab or strand in the course of the softening is avoided by the possibly reusable web material.

In addition, it has been shown to be especially advantageous if the device contains a pre-compression chamber, in which the bulk material is pre-compressible without heating, and a compression chamber adjoining in the conveyance direction, in which the bulk material is heatable and compressible and whose width measured transversely to the conveyance direction is greater than the width of the pre-compression chamber measured transversely to the conveyance direction.

Furthermore, the device according to the present invention is also refined in that the web material may be supplied to the strand or the slab between the pre-compression chamber and the compression chamber, because the problem of sticking first results in connection with the heating of the bulk material, i.e., because there is not yet any sticking danger in the compression chamber due to the lower temperatures existing therein.

Finally, the pulverization unit is driven, proceeding from an electric motor, via at least one belt drive, by which better oscillation damping and impact force reduction are achieved, and the pulverized particles obtained are suctioned off using a suction device via a screen system.

While the main intended purpose of the pulverized particles is combustion, particularly in large-scale industrial furnaces, for example, in cement factories or other power plant operations, a further possibility for material exploitation is for a slab-shaped or strip-shaped product to be obtained in turn by partial melting and compression from the particles obtained by pulverization. This strip-shaped or slab-shaped product may be used, for example, as an insulating material or as a noise absorber or noise protection material. The particles, which were previously produced by pulverization and then assembled again to form a material composite by partial melting and compression, preferably contain a component of plastic fibers, in particular in the form of fiber parts. Fibrous particle material of this type arises in particular when the starting material contains particles of textiles and/or carpets before the pulverization. In this case, fiber parts also remain after the pulverization, which ensure the required strength—like a reinforcement—in the slab-shaped or strip-shaped composite material subsequently produced by partial or complete melting. The slab or strip material produced in this way typically also contains air inclusions, so that the desired good insulation effect and, in addition, a certain flexibility result, which allow adaptation to the geometry of components to be insulated. The slabs and/or material webs produced in this way are distinguished by an astounding toughness while simultaneously having sufficient flexibility.

In order to achieve the reinforcement effect explained above, it is advantageous in particular if the included fibers comprise a material which has a higher melting point than the material of the remaining, non-fibrous particles, which preferably comprise a thermoplastic material. In this case, the thermoplastic material causes the actual binding effect, while in contrast the fibers have not reached their melting point at all and/or have merely partially melted externally during the compression and heating and were thus integrated in the composite. In order to meet the current requirements for fire protection, it is advisable to add the flame retardants known from the prior art to the pulverized particles before the recompression and melting, droplet preventers particularly also being used.

In an especially preferred embodiment of the present invention, the pulverized particles obtained are screened out, the coarser fraction having the fiber components being used to produce the slab-shaped or strip-shaped material and the finer fraction, which contains practically no fiber components, being used as a simple, high-quality replacement fuel which may be blown in without clumping. In this way, two fractions of a final product may be produced from starting materials which contain both carpet particles and also film particles, for example, one fraction of which is pre-destined as a high-quality replacement fuel and the other of which is suitable for very cost-effective production of insulation and noise absorber materials.

### BRIEF DESCRIPTION OF THE DRAWINGS

Other objects and features of the present invention will become apparent from the following detailed description considered in connection with the accompanying drawings. It should be understood, however, that the drawings are designed for the purpose of illustration only and not as a definition of the limits of the invention.

In the drawings, wherein similar reference characters denote similar elements throughout the several views:

FIG. 1 shows a perspective view of a first embodiment of a device according to the present invention,

FIG. 1a shows an enlarged perspective view of the compression unit of the device from FIG. 1,

FIG. 2 shows an enlarged illustration of the pulverizing unit of the device from FIG. 1, and

FIG. 3 shows a longitudinal section through an alternative device according to the present invention.

### DETAILED DESCRIPTION OF PREFERRED EMBODIMENTS

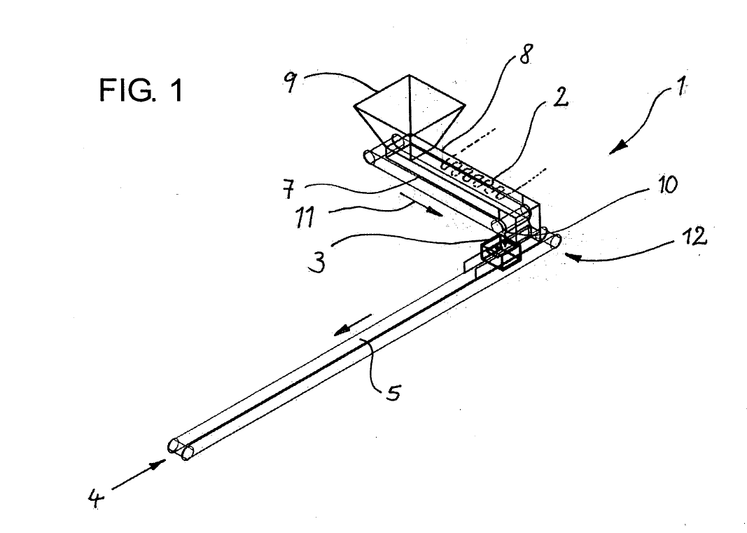

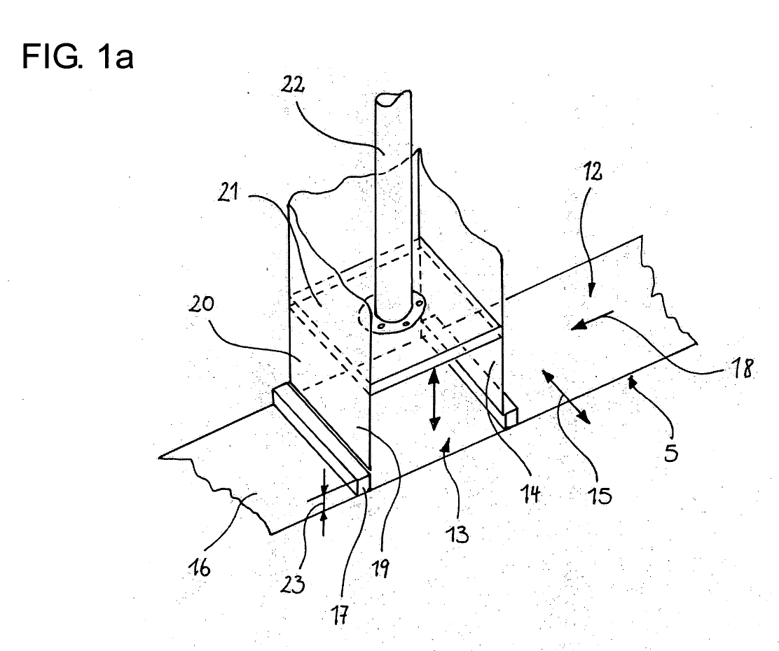

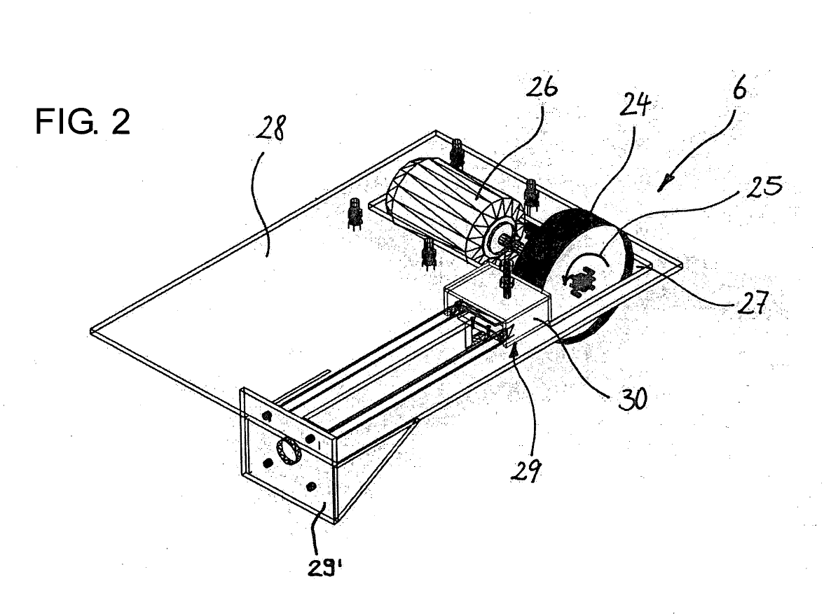

A device 1 illustrated in FIG. 1 for pulverizing bulk material containing plastic has a heating unit 2, indicated by dotted lines, for heating the bulk material, a compression unit 3 (detail see FIG. 1a) for compressing the bulk material, and a pulverizing unit 6 (not shown in FIG. 1), which follows at the end 4 of a second conveyor belt 5, and which is illustrated in greater detail in FIG. 2 and will be explained later.

The device 1 has a first conveyor belt 7, via which a closed channel 8 is implemented, which comprises two vertically oriented side walls and a horizontally oriented cover sheet. A conveyor cross-section for bulk material, which is conveyed lying on the conveyor surface of the conveyor belt 7, is located below the cover sheet within the channel 8. The bulk material reaches the channel 8 via a filling funnel 9 and is continuously heated on the path in the direction toward the end 10 of the conveyor belt 7 with the aid of the heating unit 2 enough that the conveyed bulk material partially melts at least superficially and/or regionally and forms a lightly coherent composite, whose volume is already smaller than the original volume of the bulk material in its coarse grain, since the material has collapsed because of the plastification and air inclusions were eliminated in this way.

The heating unit 2 is illustrated solely for exemplary purposes as an electrical resistance heater in the form of heating coils. Alternatively and/or additionally, all other types of heating units are also conceivable, in particular heaters having direct firing by gas, oil, or other liquid, solid, or gaseous fuels. Purely convective heating using hot gas conducted over the conveyed bulk material is also conceivable. A transfer of the conveyor stream, which is provided there at least in the partially melted state, occurs, induced by gravity, at the front end of the first conveyor belt 7 in the conveyance direction (cf. arrow 11) to a second conveyor belt 5 running at a right angle to the first conveyor belt 7. The conveyor belt 5 is situated lower by a certain amount in the vertical direction than the conveyor belt 7 provided with the channel 8.

The conveyor belt 7 is operated and delivers a constant quantity of molten bulk material in coarse grain in the area of the discharge line of the conveyor belt to a collection chamber 12 above the conveyor belt 5 until the collection chamber 12, which is delimited on all sides by side walls, has reached a sufficient fill level.

The conveyor belt 7 then stops and thus interrupts the further discharge of molten bulk material in coarse grain. Because of the partially molten state, the plastic material to be pulverized, which is provided in this way and which contains thermoplastic components, may be permanently compressed to form a slab. However, before the compression procedure it is not such a solidly coherent composite that even in the event of a conveyor interruption of the conveyor belt 7 a kind of strand of the bulk material would hang down from the conveyor belt 7 into the collection chamber 12. Rather, because of gravity, the stream of the bulk material is cut off in the area of the discharge line of the conveyor belt 7.

FIG. 1a shows an enlarged illustration of a compression chamber 13 of the compression unit 3, which is located above the conveyor belt 5. The collection chamber 12, whose side walls are not shown in FIG. 1a for the sake of clarity, is located before the compression chamber 13 in the conveyance direction. A side wall 14 of the compression chamber 13 is simultaneously also a side wall of the collection chamber 12. In order to allow a transfer from the collection chamber 12 into the compression chamber 13, the side wall 14 is displaceable in the horizontal direction (see double arrow 15) and may be removed entirely from the conveyor cross-section of the conveyor belt 5 when the belt moves.

Multiple strips 17, which are situated distributed equidistantly over the entire length of the conveyor belt 5, are located projecting above the conveyor surface 16 of the conveyor belt 5. The clearance between two neighboring strips 17 corresponds to the distance, measured in the horizontal direction, of the side wall 14 from a further side wall 19 oriented perpendicularly to the conveyance direction (arrow 18) of the conveyor belt 5. The strip distance also corresponds to the width of the first conveyor belt 7. The lateral enclosure of the compression chamber 13 is completed by a rear side wall 20 oriented parallel to the conveyance direction 18 and a front side wall which is not shown in FIG. 1a for the sake of simplicity.

After the side wall 14 has, like a horizontally movable bulkhead, initially released the path for the transfer of the quantity of the collected bulk material collected in the collection chamber 12, a closing movement of this side wall 14 again occurs in order to completely enclose the compression chamber 13.

A ram 21, which is movable in the vertical direction, having a piston rod 22 then moves. The partially molten bulk material is converted from its loose bulk into a compact state essentially without gas inclusions. The compression stroke of the ram 21 is essentially permanently predefined. The thickness of the compressed slab essentially corresponds to the height 23 of the strips 17, so that after the ram 21 is retracted and the conveyor belt 5 moves further, this conveyor belt may be moved through below the fixed side wall 19 together with the strips 17 and the compressed slabs lying between them.

FIG. 2 shows an enlarged perspective illustration of the pulverizing unit 6, which essentially comprises a rasping disk 24 or roller, which is provided around its circumference with multiple cutting blades (not shown in the figure). The rasping disk rotates in the direction of the arrow 25 and is driven by an electric motor 26. The rasping disk 24 is located within a section 27 in a pulverizing table 28, on which the slabs which have left the end 4 of the conveyor belt 5 may be conveyed. The slabs may be supplied to the pulverizing table 28 in a direction parallel to the axis of rotation of the rasping disk 24 and/or the electric motor 26, for example.

An advancing unit 29 having a pressing element 30 ensures that the slabs may be conveyed continuously to the rasping disk 24. The pressing element 30, which may be moved with the aid of a pneumatic cylinder (not shown), which may be attached to a flange 29′, is shown in a position in FIG. 2 in which is located at a minimum distance from the rasping disk 24. From this position, the pressing element 30 may be retracted back into its starting position, in which a new slab may be situated between the pressing element 30 and the rasping disk 24 in order to continue the pulverizing process.

The bulk material converted into the smaller grain is removed by suction below the pulverizing table 28, whose edge acts as a counter blade in the area of the contact zone between the slab to be rasped and the rasping disk 24, and is subsequently also separated by screening, for example, into various grain size ranges.

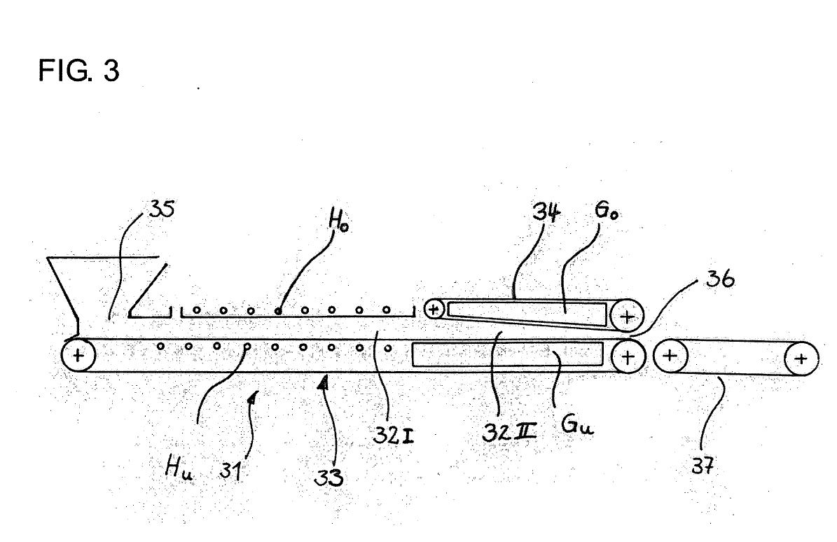

Finally, FIG. 3 also shows an alternative device 31, in which the stream of the bulk material is first [word missing] in a gap 32 I having constant cross-section and subsequently in a continuously tapering gap 32 II implemented between a lower conveyor belt 33 and an upper conveyor belt 34. A delivery funnel 30 for the bulk material to be delivered in the coarse grain is located before the the beginning of the gap 32 I. Below the section which faces toward the gap 32 II, both conveyor belt 33 and 34 have a support (not shown in greater detail) in the form of sliding tables Gᵤ, Gₒ, which prevent the particular section from being pressed through as the bulk material is compressed.

In the exemplary embodiment from FIG. 3, the melting and compression of the bulk material stream occurs continuously. Two heating units Hᵤ, Hₒ, which are not shown in greater detail, are located above the entire length of the gap 32 I. They may also be situated having a part between the two sections of the upper conveyor belt 34 and having another part between the two sections of the lower conveyor belt 33. Electrical resistance heaters are preferably used here, but situating heating channels for a liquid heat conductor medium within the sliding tables Gᵤ, Gₒ is also conceivable.

A continuous strand of the compressed bulk material exits from the delivery cross-section 36, which is then taken over by a further conveyor belt 37. Cooling of the strand occurs in the course of the conveyor belt 37, the cooling being able to be actively encouraged by using specific coolants (cold water, cold air, etc.). A pulverizing unit (not shown in greater detail) is situated at the end of the cooling line, which pulverizes the cooled strand arriving there continuously into the smaller grain. Thus, for example, a pulverizing unit as shown in FIG. 2 may be used, with the proviso that the advancing unit 29 may be dispensed with and replaced by a guide unit for the strand which prevents horizontal and vertical yielding movements thereof. An additional conveyor unit in the form of an abrasion wheel having specific formfitting elements may also be provided to generate the required contact pressure force on the rasping disk. A guide unit for preventing yielding movements of the slab is also conceivable with the pulverizing unit 3 from FIG. 2.

Although only a few embodiments of the present invention have been shown and described, it is to be understood that many changes and modifications may be made thereunto without departing from the spirit and scope of the invention as defined in the appended claims.

1. A method for pulverizing bulk material containing plastic, whose grain is highly flexible and whose loose bulk is highly compressible and which is initially provided in a coarse grain, is subsequently heated and compressed, and then converted into a finer grain, wherein the bulk material, which at least partially contains thermoplastics, is at least partially melted before and/or during and/or after the compression in such a way that it is provided in the form of an endless strand or a slab after the compression and heating, which is cooled and converted into the finer grain in a coherent state using a cutting tool, the thickness of the strand or the slab being between 5 mm and 100 mm, preferably between 10 mm and 50 mm, and the bulk material in the finer grain having a grain size in the range from 0.0 mm to 20 mm, preferably from 0.0 mm to 5.0 mm, more preferably from 0.0 to 2.0 mm.

2. The method according to claim 1, wherein the bulk material is conveyed during the heating using a conveyor belt (7) and heated using a heating unit (2) situated above the conveyor belt (7).

3. The method according to claim 1, wherein the heating time, during which the bulk material is stationary, is at least 20 seconds, preferably at least 30 seconds.

4. The method according to claim 1, wherein the heating temperature is between 200° C. and 250° C. and the bulk material is compressed during the heating and/or already previously.

5. The method according to claim 1, wherein the bulk material is conveyed during the compression between two conveyor belts (33, 34) or two rolls, the conveyor cross-section decreasing in the conveyance direction to a delivery cross-section (36), whose height corresponds to the thickness of the strand or the slab.

6. The method according to claim 1, wherein a continuously or discontinuously conveyed stream of the bulk material is melted before the compression and then transferred into a compression area or compression chamber (13) and compressed therein using a ram (21).

7. The method according to claim 6, wherein the stream of the bulk material is transferred into a collection chamber (12) before the transfer into the compression chamber (13) and the quantity of the partially molten bulk material collected therein is transferred into the compression chamber (13), the collection chamber (12) and the compression chamber (13) being located above a conveyor belt (5) which delimits the two chambers (12, 13) on the bottom.

8. The method according to claim 1, wherein the stream of the partially molten bulk material is transferred by gravity from a first conveyor belt (7) into the collection chamber (12), the movement of the conveyor belt (7) being temporarily interrupted to also interrupt the transfer of the stream of the bulk material into the collection chamber (12).

9. A device (1, 31) for pulverizing bulk material containing plastic, whose grain is highly flexible and whose loose bulk is highly compressible, and which is initially provided in a coarse grain, the device having a heating unit (2) for heating the bulk material, a compression unit (3) for compressing the bulk material, and a pulverizing unit (6) for converting the bulk material into a finer grain, wherein the bulk material, which at least partially contains thermoplastics, may be at least partially melted using a heating unit (2) before and/or during and/or after the compression in such a way that it is provided after the compression and heating in the form of an endless strand or a slab, and an endless strand or a slab of the bulk material is producible using the compression unit (3), the thickness of the strand or the slab being between 5 mm and 100 mm, preferably between 10 mm and 50 mm, and a bulk material being producible using the pulverizing unit (6) from the strand or slab in the cooled state having a finer grain size which is between 0.0 mm and 20 mm, preferably between 0.0 mm and 5.0 mm, more preferably from 0 to 2.0 mm.

10. The device according to claim 9, wherein the bulk material may be conveyed below the heating unit (2) using a conveyor unit, preferably a conveyor belt (7, 33).

11. The device according to claim 9, wherein the compression unit (3) has a ram (21), using which the partially molten bulk material is compressible in a compression chamber (13), whose bottom is preferably formed by a further conveyor belt (5) and which has side walls (14, 19, 20) to prevent a lateral yielding movement of the bulk material to be compressed.

12. The device according to claim 11, wherein the further conveyor belt (5) is provided with strips (17), which project above the conveyor surface and are situated distributed equidistantly to one another in the longitudinal direction of the conveyor belt (5), whose clearance to one another corresponds to the length of a slab compressed in the compression chamber (13) and whose height (23) corresponds to the thickness of the compressed slab, the side walls (14, 19) of the compression chamber (13) being situated at a vertical distance above the conveyor surface of the conveyor belt (5) which is slightly greater than the height of the strips (17).

13. The device according to claim 9, wherein the pulverizing unit (6) comprises multiple annular rasping disks having rasping teeth projecting around the circumference, which are joinable to one another axially, each individual rasping disk comprising multiple disk segments joined to one another around the circumference, which may be pushed using holes onto retention rods running parallel to one another in the axial direction, which may in turn be clamped between two clamping disks delimiting an assembly of the rasping disks at both ends.

14. The device according to claim 9, wherein a web material, preferably a paper, may be supplied to the bulk material before the heating on the top and/or the bottom of the strand or slab to be formed, the web material, whose width at least corresponds to the width of the strand to be formed, being able to be unwound from a roll before being supplied to the strand or the slab and being able to the wound onto a roll after the separation from the strand or the slab.

15. The device according to claim 9, wherein a pre-compression chamber, in which the bulk material is pre-compressible without heating, and a compression chamber, adjoining in the conveyance direction, in which the bulk material is suitable and compressible and whose width measured transversely to the conveyance direction is greater than the width of the pre-compression chamber measured transversely to the conveyance direction.

16. The device according to claim 14, wherein the web material may be supplied to the strand or the slab between the pre-compression chamber and the compression chamber.
